(19) United States
(12) Patent Application Publication
(10) Pub. No.: US 2026/0125263 A1
(43) Pub. Date: May 7, 2026

(54) RADIANT SYNGAS COOLER

(71) Applicant: Air Products and Chemicals, Inc., Allentown, PA (US)

(72) Inventors: YAN ZHAO, Allentown, PA (US); WEI XIN, Beijing (CN); SHUIGANG LIU, Beijing (CN); MICAH S. KIFFER, Kutztown, PA (US); JEFFREY W. KLOOSTERMAN, Allentown, PA (US)

(73) Assignee: Air Products and Chemicals, Inc., Allentown, PA (US)

(21) Appl. No.: 18/937,307

(22) Filed: Nov. 5, 2024

(51) Int. Cl. C01B 3/36

(52) U.S. Cl. CPC C01B 3/36; C01B 2203/0255; C01B 2203/0883

(57) ABSTRACT

A system comprising a gasifier comprising one or more burners configured to accept a carbonaceous fuel and an oxidant to produce a syngas and a molten slag; a throat configured to accept the syngas and molten slag from the gasifier; and a radiant syngas cooler positioned below the gasifier configured to accept the syngas and molten slag from the throat; wherein the throat comprises an outer wall and one or more fins extending radially inwards from the outer wall.

### BACKGROUND

The partial combustion or gasification of carbonaceous fuels to produce synthesis gases, or syngas, having value as residential and industrial fuels, as starting materials for synthesis of chemicals and fuels, and as an energy source for generation of electricity has long been recognized and practiced on varying scales throughout the world. The term “carbonaceous fuel” as used herein is intended to also include various gas-carried and/or liquid-carried solid combustible materials and mixtures thereof, and may be selected from the group of coal, coke from coal, coal liquefaction residues, petroleum coke, soot, biomass, and particulate solids derived from oil shale, tar sands and pitch. The coal may be of any type, including lignite, sub-bituminous, bituminous and anthracite.

A gasification reactor produces hot syngas comprising hydrogen and carbon monoxide which may be contacted with one or more heat exchangers to recover high quality heat as steam. One such heat exchanger is a radiant syngas cooler, or RSC. An RSC is a large and complex piece of capital equipment that provides a large heat exchange area within the pressure vessel in which radiative heat transfer plays a significant role. A key challenge to the use of an RSC is preventing molten slag from adhering to the heat exchange surface before solidifying, which may foul the cooling surface. In a gasifier with swirling flow, molten slag may be flung outwards towards the cooling surface, making fouling even more likely.

### BRIEF DESCRIPTION OF THE DRAWINGS

The present invention will hereinafter be described in conjunction with the appended figures wherein like numerals denote like elements:

FIG. 1 is a schematic view of a cutaway profile of a gasifier, throat, and radiant syngas cooler according to one or more aspects of the present invention.

FIG. 2 is a top-down plan view of a gasifier in a swirling flow configuration.

FIG. 3 is a top-down plan view of the gasifier of FIG. 2, zoomed in on a view of a throat with fins.

FIG. 4 is a top-down cross-section of a throat in which the outer wall and one or more fins comprise cooling tubes.

FIG. 5 is a modification of FIG. 4 in which the one or more fins are positioned with a fin angle.

FIG. 6 is a side view of a fin according to one or more aspects of the present invention.

FIG. 7A is a simplified plot of simulated tangential velocities for a throat with 14 fins with zero fin angle.

FIG. 7B is a simplified plot of simulated axial velocities for a throat with 14 fins with zero fin angle.

FIG. 8A is a drawing illustrating the qualitative effect of having no fins in the throat on the flow patterns of the syngas.

FIG. 8B is a drawing illustrating the qualitative effect of having a throat with one or more fins having zero fin angle on the flow patterns of the syngas.

FIG. 8C is a drawing illustrating the qualitative effect of having a throat with one or more fins having a fin angle in the same direction as the swirling flow on the flow patterns of the syngas.

### DETAILED DESCRIPTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. Various changes may be made in the function and arrangement of elements without departing from the spirit and scope of the invention, as set forth in the appended claims.

The articles “a” or “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

The term “and/or” placed between a first entity and a second entity includes any of the meanings of (1) only the first entity, (2) only the second entity, or (3) the first entity and the second entity. The term “and/or” placed between the last two entities of a list of 3 or more entities means at least one of the entities in the list including any specific combination of entities in this list. For example, “A, B and/or C” has the same meaning as “A and/or B and/or C” and comprises the following combinations of A, B and C: (1) only A, (2) only B, (3) only C, (4) A and B but not C, (5) A and C but not B, (6) B and C but not A, and (7) A and B and C.

The adjective “any”means one, some, or all, indiscriminately of quantity.

In accordance with the present embodiments, a gasifier is arranged vertically above a radiant syngas cooler. The gasifier may have one or more injectors to deliver a carbonaceous fuel to react with oxygen to produce syngas and slag. The carbonaceous fuel may be solid, liquid, or gas phase, and may include solid phase carbonaceous fuel suspended in a gas-or liquid-phase carrier. The one or more injectors may be positioned to deliver carbonaceous fuel from the top and/or sides of the gasifier. The gasifier is connected to the radiant syngas cooler via a throat that may comprise one or more fins extending in from an outer wall towards the center of the throat. The throat may have a smaller diameter than the gasifier and/or the RSC. The outer wall may comprise a refractory material. The outer wall may comprise one or more conduits, such as tubes, configured to transport a coolant. The outer wall may comprise a membrane wall in which a liquid coolant flows between the outer wall and the syngas. The outer wall may be circular in cross section. The one or more fins may comprise a refractory material. The one or more fins may comprise one or more conduits, such as tubes, configured to transport a coolant. The one or more fins may comprise a membrane wall. The one or more fins may terminate at points that define a core section. Syngas may be produced in the gasifier with a swirling velocity as it exits the gasifier, which may be defined as having two components: a downward axial velocity and a tangential velocity. A swirling velocity may be imparted on the syngas by placing the side injectors on a swirl angle with respect to a line drawn from the side injectors to the center of the gasifier. The swirl angle for the side injectors may range from 3° to 6°. The swirl angle for the side injectors may be equal. If the syngas enters the RSC with a significant tangential velocity, entrained slag may impinge on heat exchange surfaces in the RSC while still molten, fouling the RSC. The one or more fins may reduce or eliminate the tangential velocity of the syngas near the outer wall. The core section may maintain enough tangential velocity to benefit from the stabilizing effect of swirling flow in the center of the throat. As the syngas enters the throat, having the syngas flow velocity dominated by the downward axial velocity near the throat outer wall may reduce or eliminate the adhesion of slag to the heat exchange surfaces. The one or more fins extending in towards the center of the throat may be pointed directly at the center of the throat, or be placed with a fin angle, where the fin angle is defined with respect to a line drawn from the intersection of the one or more fins with the throat outer wall to the center of the throat. The fin angle may be in the same direction relative to the swirl angle of the burners, which may cause the flow of the syngas passing by one fin to hit the next fin in a more perpendicular angle which in turn may reduce tangential velocity more than in a case in which the fin angle is zero. The one or more fins may be spaced evenly along the circumference of the throat outer wall wherein the spacing angle between each fin is equal to 2π/n, where n is equal to the number of fins. The fin angle may range from 0 to the spacing angle, or from ¼ to ¾ of the spacing angle, or be about half of the spacing angle.

The one or more fins may be designed to extend into the throat with a characteristic fin height less than ½ R_{T} where R_{T} is the radius of the throat, or ranging from the width of the one or more fins to ½ R_{T}, or from 1/12 R_{T} to ½ R_{T}, or from ⅙ R_{T} to ½ R_{T}, or from 0.2 R_{T} to 0.4 R_{T}. The fin height may be large enough to stop swirling flow between the fins, but not so large that the swirling flow in the central throat section is impeded. The fin height may be selected to balance the area of the central throat section with the cumulative area between the one or more fins. The one or more fins may be designed to extend along the length of the throat with a characteristic fin length of at least 0.5 R_{T} (with the upper bound on fin length equaling the length of the throat itself), or ranging from 0.5 R_{T} to 4 R_{T}, or from 1 R_{T} to 3 R_{T}. The one or more fins may extend along the length of the RSC with enough distance to establish a stable flow pattern. The one or more fins may be designed to terminate prior to the exit of the throat, with a length ranging from 0.5 m to 2 m. The one or more fins may terminate prior to the exit of the throat in order to catch slag droplets originating from the bottom of the one or more fins. The bottom edge of the one or more fins (i.e. the end of the one or more fins nearest the exit of the throat) may form an angle between the bottom edge of the one or more fins and the outer wall of the throat greater than 90°.

A person of skill in the art would appreciate that increasing the surface area of the RSC would be expected to increase the risk of slag adhering to the heat exchange surfaces, restricting flow and potentially plugging the gasifier. To prevent this, especially in the case of swirling syngas flow, the prior art teaches the use of a liquid water film to protect the walls of the heat exchange surfaces. Surprisingly, the downflowing syngas through the RSC keeps the slag molten, allowing slag discharge and mitigating risk of slag freezing. A molten state for slag may be defined as having a viscosity less than 100 Pa*s. The increase in heat exchange surface does increase the temperature drop of the syngas through the RSC, but the effect is not great enough to have a material impact on operation. Instead of attempting to stop swirling flow, the design of the one or more fins pushes the swirling flow towards the center of the RSC and away from the walls.

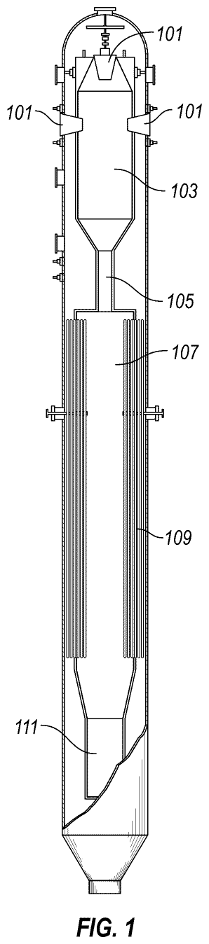

FIG. 1 is a schematic view of a cutaway profile of a gasifier, throat, and radiant syngas cooler. One or more injectors 101 deliver a carbonaceous fuel and/or oxygen, which may be suspended in a gas or liquid carrier fluid, into a gasifier 103 where the carbonaceous fuel is partially oxidized to form syngas and slag. The syngas and slag flow down into the narrower throat section 105 before entering the RSC 107. In the RSC 107, the syngas and slag may exchange heat with one or more heat transfer surfaces 109. The one or more heat transfer surfaces 109 may heat and boil water to produce steam. The syngas and slag may then enter quench chamber 111 and be directly contacted with a liquid water stream to further cool the syngas and separate the slag from the syngas.

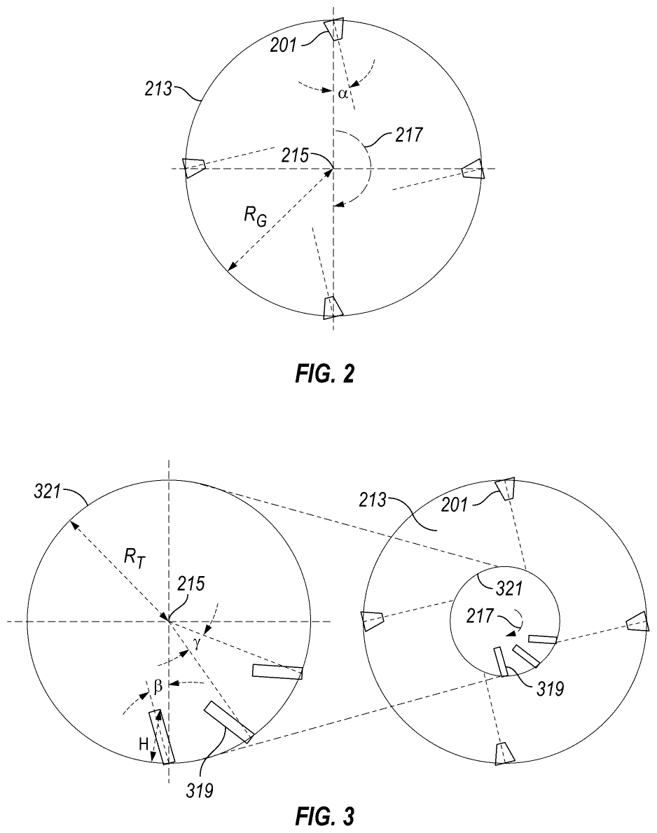

FIG. 2 is a top-down plan view of a gasifier in a swirling flow configuration. One or more injectors 201 are positioned to form a swirl angle a with a line drawn from the point where the one or more injectors 201 meet the gasifier wall 213 to the center of the gasifier 215. The swirl angle α may be defined as positive when in a clockwise direction 217 as viewed from above, and negative when in a counter-clockwise direction. In FIG. 2 the one or more burners 201 are positioned with a positive swirl angle a which may impart a positive tangential velocity to the syngas and entrained molten slag. The radius of the gasifier may be defined as R_{G}.

FIG. 3 is a top-down plan view of the gasifier of FIG. 2, zoomed in on a view of a throat with fins. One or more fins 319 are attached to the throat outer wall 321. The one or more fins 319 may form a fin angle β with a line drawn from the point where the one or more fins 319 meet the throat outer wall 321 to the center of the gasifier 215. In the embodiment shown in FIG. 3, the swirl angle α and the fin angle β are in the same positive direction. The one or more fins 319 may have a spacing angle γ between the points where the one or more fins 319 meet the throat outer wall 321. The fin height H may be defined as the maximum distance the one or more fins extend into the throat towards the center of the gasifier 215. The radius of the throat may be defined as R_{T}.

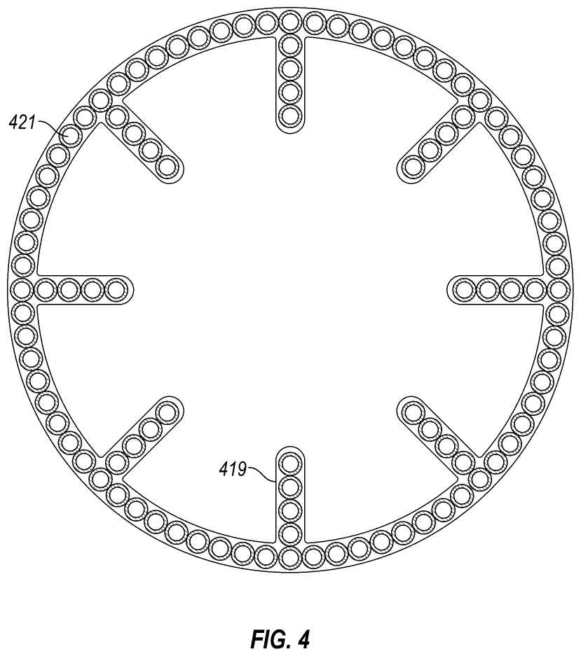

FIG. 4 is a top-down cross-section of a throat in which the throat outer wall 421 and one or more fins 419 comprise cooling tubes. A coolant such as water may flow up or down through each tube to cool and protect the material in the throat outer wall and/or one or more fins.

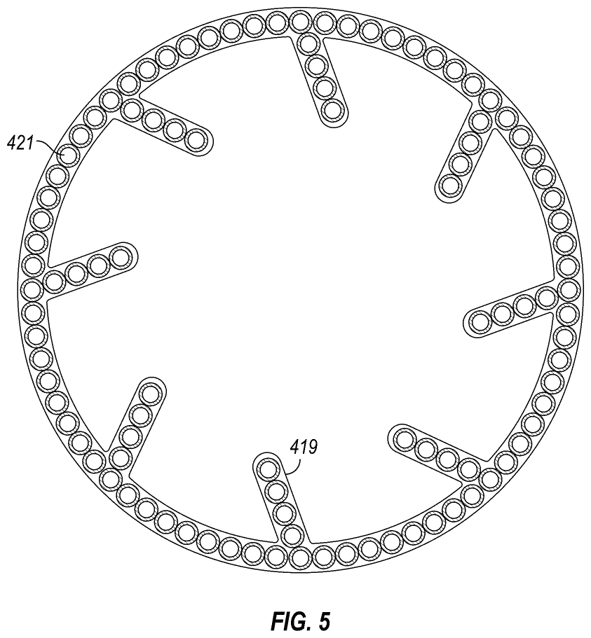

FIG. 5 is a modification of FIG. 4 in which the one or more fins 419 are positioned with a fin angle. This modification may reduce the tangential velocity of the syngas in the spaces between the one or more fins 419.

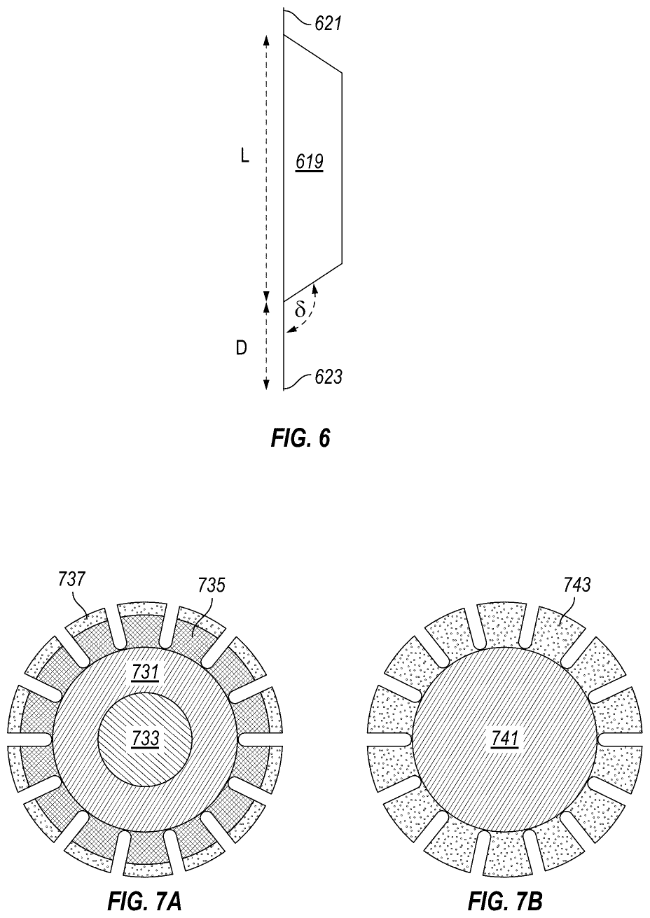

FIG. 6 is a side view of a fin according to one or more aspects of the present invention. The fin 619 may be defined as having a length L and may terminate a distance D from an exit 623 of the throat. On the downstream side of the fin 619, the fin may meet the outer wall 621 at a fin termination angle δ which may be greater than 90°.
Aspect 1: A system comprising a gasifier comprising one or more burners configured to accept a carbonaceous fuel and an oxidant to produce a syngas and a molten slag; a throat configured to accept the syngas and molten slag from the gasifier; and a radiant syngas cooler positioned below the gasifier configured to accept the syngas and molten slag from the throat; wherein the throat comprises an outer wall and one or more fins extending radially inwards from the outer wall.
Aspect 2: A system according to Aspect 1, wherein the outer wall comprises one or more conduits configured to transport a coolant.
Aspect 3: A system according to Aspects 1 or 2, wherein the one or more fins comprise one or more conduits configured to transport a coolant.
Aspect 4: A system according to any of Aspects 1 to 3, wherein the one or more fins are angled with respect to a line drawn from the intersection of the one or more fins with the outer wall of the throat to the center of the throat.
Aspect 5: A system according to Aspect 4, wherein the gasifier has a geometric center and wherein the one or more burners are angled with respect to a line drawn from the one or more burners to the geometric center of the burner.
Aspect 6: A system according to Aspect 5, wherein the angle of the one or more burners is in the same direction as the angle of the one or more fins.
Aspect 7: A system according to any of Aspects 1 to 6, wherein the one or more fins extend into the throat by a value between 1/12 and ½ of the distance from the outer wall of the throat to the center of the throat.
Aspect 8: A system according to any of Aspects 1 to 7, wherein the one or more fins terminate in an axial direction ranging from 0.5 m to 2 m from an outlet of the throat.
Aspect 9: A system according to Aspect 8, wherein a bottom edge of the one or more fins makes an angle greater than 90° with the outer wall of the throat at the point where the one or more fins terminate in an axial direction towards an outlet of the throat.
Aspect 10: A system according to any of Aspects 1 to 9, wherein the one or more fins have a fin length in the axial direction of at least 0.5 times of a distance from the outer wall of the throat to the center of the throat.
Aspect 11: A method comprising providing a carbonaceous fuel and an oxidant to a gasifier comprising one or more burners to produce a syngas and a molten slag; providing the syngas and the molten slag to a throat configured to accept the syngas and molten slag from the gasifier; and providing the syngas and the molten slag from the throat to a radiant syngas cooler positioned below the gasifier configured to accept the syngas and molten slag from the throat; wherein the throat comprises an outer wall and one or more fins extending radially inwards from the outer wall.
Aspect 12: A method according to Aspect 11, wherein the slag has a viscosity less than 100 Pa*sec.
Aspect 13: A method according to Aspects 11 or 12, wherein the one or more fins are angled with respect to a line drawn from the intersection of the one or more fins with the outer wall of the throat to the center of the throat.
Aspect 14: A method according to Aspect 13, wherein the syngas stream has a swirl velocity in the same direction as the angle of the one or more fins.
Aspect 15: A method according to any of Aspects 11 to 14, further comprising flowing a coolant through an interior space of the outer wall of the throat and/or the one or more fins.

### EXAMPLES

The flow of a swirling syngas in a finned throat was simulated using Fluent® computational fluid dynamics software, available from Ansys. FIG. 7A is a simplified plot of simulated tangential velocities for a throat with 14 fins with zero fin angle. FIG. 7B is a simplified plot of simulated axial velocities for a throat with 14 fins with zero fin angle. The tangential velocity of the syngas may be grouped into four regimes: a first section 731 just inside the fins with a maximum tangential velocity, followed by a second section 733 in the center of the throat with a moderate tangential velocity, followed by a third section 735 in the center of the spaces between the fins with the minimum tangential velocity, and a fourth section 737 adjacent to the throat outer wall with a moderate tangential velocity in a direction opposite to the tangential velocity of the syngas entering the throat. This illustrates the positive effect the fins have on flow patterns in the throat as the tangential velocity that may fling slag outwards to adhere to the throat outer wall is reduced in the spaces between the fins. However, the zero fin angle on the fins may cause a recirculation loop within the spaces between the fins as seen in the reverse flow near the throat outer wall. The axial velocity of the gas may be grouped into two regimes: a fifth section 741 with more rapid downward axial velocity through a central core of the throat and a sixth section 743 with a slower downward axial velocity between the fins. The axial velocity in the sixth section 743 is still sufficient to carry slag down through the spaces between the fins.

The effect of fin angle was tested by positioning the 14 fins on a fin angle of 10°. The angle was chosen such that the syngas passing by one fin would impact the following fin approximately perpendicularly. Tangential velocity near the throat outer wall was reduced by about one order of magnitude, showing greatly reduced secondary swirling flow in the spaces between the fins.

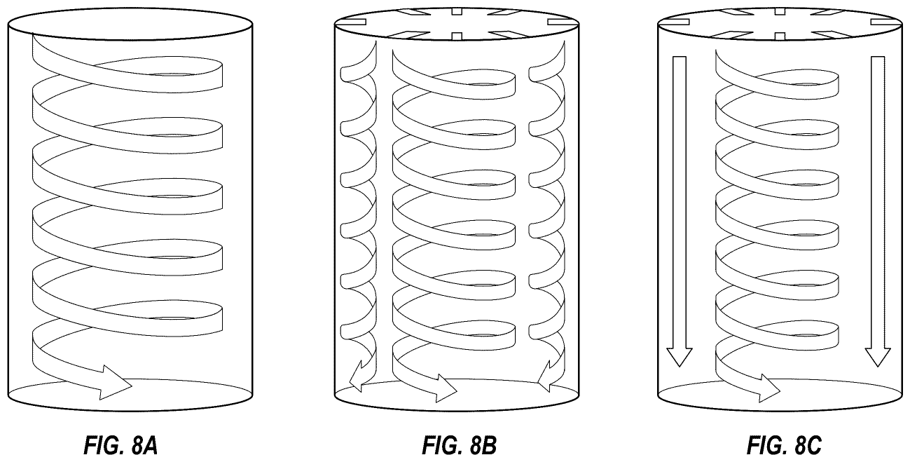

FIG. 8A is a drawing illustrating the qualitative effect of having no fins in the throat on the flow patterns of the syngas. For a throat with no fins the syngas flows downward in a swirling spiral with a high risk of impinging any suspended slag on the throat outer wall. FIG. 8B is a drawing illustrating the qualitative effect of having a throat with one or more fins having zero fin angle on the flow patterns of the syngas. The swirling flow is partially confined to the central core inside the one or more fins, but a secondary swirling flow (which may be in the opposite direction of the swirl in the central core) may persist in the space between the fins. FIG. 8C is a drawing illustrating the qualitative effect of having a throat with one or more fins having a fin angle in the same direction as the swirling flow on the flow patterns of the syngas. The swirling flow is almost entirely confined to the central core and the flow in the space between the fins is almost entirely in the downward direction, carrying slag straight down and out of the throat into the RSC.

While the principles of the invention have been described above in connection with preferred embodiments, it is to be clearly understood that this description is made only by way of example and not as a limitation of the scope of the invention.

1. A system comprising:
a gasifier comprising one or more burners configured to accept a carbonaceous fuel and an oxidant to produce a syngas and a molten slag;
a throat configured to accept the syngas and molten slag from the gasifier; and
a radiant syngas cooler positioned below the gasifier configured to accept the syngas and molten slag from the throat;
wherein the throat comprises an outer wall and one or more fins extending radially inwards from the outer wall.

2. The system of claim 1, wherein the outer wall comprises one or more conduits configured to transport a coolant.

3. The system of claim 1, wherein the one or more fins comprise one or more conduits configured to transport a coolant.

4. The system of claim 1, wherein the one or more fins are angled with respect to a line drawn from the intersection of the one or more fins with the outer wall of the throat to the center of the throat.

5. The system of claim 4, wherein the gasifier has a geometric center and wherein the one or more burners are angled with respect to a line drawn from the one or more burners to the geometric center of the burner.

6. The system of claim 5, wherein the angle of the one or more burners is in the same direction as the angle of the one or more fins.

7. The system of claim 1, wherein the one or more fins extend into the throat by a value between 1/12 and ½ of the distance from the outer wall of the throat to the center of the throat.

8. The system of claim 1, wherein the one or more fins terminate in an axial direction ranging from 0.5 m to 2 m from an outlet of the throat.

9. The system of claim 8, wherein a bottom edge of the one or more fins makes an angle greater than 90° with the outer wall of the throat at the point where the one or more fins terminate in an axial direction towards an outlet of the throat.

10. The system of claim 1, wherein the one or more fins have a fin length in the axial direction of at least 0.5 times of a distance from the outer wall of the throat to the center of the throat.

11. A method comprising:
providing a carbonaceous fuel and an oxidant to a gasifier comprising one or more burners to produce a syngas and a molten slag;
providing the syngas and the molten slag to a throat configured to accept the syngas and molten slag from the gasifier; and
providing the syngas and the molten slag from the throat to a radiant syngas cooler positioned below the gasifier configured to accept the syngas and molten slag from the throat;
wherein the throat comprises an outer wall and one or more fins extending radially inwards from the outer wall.

12. The method of claim 11, wherein the slag has a viscosity less than 100 Pa*sec.

13. The method of claim 11, wherein the one or more fins are angled with respect to a line drawn from the intersection of the one or more fins with the outer wall of the throat to the center of the throat.

14. The method of claim 13, wherein the syngas stream has a swirl velocity in the same direction as the angle of the one or more fins.

15. The method of claim 11, further comprising flowing a coolant through an interior space of the outer wall of the throat and/or the one or more fins.
